(19) United States
(12) Patent Application Publication
(10) Pub. No.: US 2018/0044999 A1
(43) Pub. Date: Feb. 15, 2018

(54) DEVICE AND METHOD FOR SECURING CONDUIT INTERIOR WEAR SLEEVE

(71) Applicant: Evolution Engineering Inc., Calgary, Alberta (CA)

(72) Inventors: Luke Anthony Stack, Calgary, Alberta (CA); Dave Switzer, Calgary, Alberta (CA); Justin Christopher Logan, Calgary, Alberta (CA); Aaron William Logan, Calgary, Alberta (CA)

(21) Appl. No.: 15/549,794

(22) PCT Filed: Feb. 11, 2016
(86) PCT No.: PCT/CA2016/000033

§ 371 Date: Aug. 9, 2017

Related U.S. Application Data
(60) Provisional application No. 62/116,003, filed on Feb. 13, 2015.

(51) Int. Cl. E21B 17/10; F16L 58/10; E21B 17/00; F16L 57/06

(52) U.S. Cl. CPC E21B 17/1007; F16L 57/06; F16L 58/1036; E21B 17/003; E21B 47/122

(57) ABSTRACT

A device and method for securing a sleeve (for sacrificial wear and/or electrical isolation) inside a conduit. In one embodiment, the retention device sits adjacent one end of the sleeve and comprises a ring having a protuberance or lip extending parallel to and against the end of the sleeve, thus pressing the end of the sleeve against the inner surface of the conduit. This has the advantage, in situations where fluids are flowing through the conduit, of reducing the risk of fluids moving behind the sleeve and collapsing it inwardly.

### FIELD OF THE INVENTION

The present invention relates to protective techniques and methodologies for conduit interiors, and more specifically to the use of sleeves as wear members or electrical insulators.

### BACKGROUND OF THE INVENTION

It is known in the art of conduit design to employ covers or coatings to protect the inner conduit surfaces from corrosion or undue wear, as abrasive liquid/solid mixtures are often transported in a pipeline or conduit. The covers may be manufactured separately and inserted into the conduit, or they may be in the form of a spray-coating or similar application technique. The cover or sleeve material is commonly in the form of a plastic or metal material, the specific material selected on the basis of the application and the type, volume and velocity of fluid flow through the conduit.

For example, U.S. Pat. No. 8,397,766 to Rosen teaches a pipe welding method wherein adjacent pipe sections are provided with a plastic lining. The plastic lining may be secured in place by means such as an adhesive coating.

The use of a plastic liner or sleeve is also known to have potential advantages in the field of downhole electromagnetic telemetry, as commonly-used gap subs employ some degree of electrical isolation for operation. As is taught in Patent Cooperation Treaty Application No. PCT/CA2013/050850 to Logan et al., an electrically insulative sleeve can be used with a gap sub.

However, it is known that sleeves can be dislodged by normal fluid flow through a conduit, particularly in the context of drilling fluids or other high-velocity applications, as the fluids can flow behind the leading or upstream edge of the sleeve and eventually collapse it inwardly. This can have significant negative consequences where, for example, the conduit houses a probe or other tool, which is often found in gap sub assemblies.

Some solutions have been proposed, such as using an adhesive to retain the sleeve against the conduit inner walls, but this makes it more difficult to remove the sleeve. In the situation where the sleeve is sacrificial and is intended to be replaced from time to time, having the sleeve glued in place renders such replacements difficult. Additional time and cost may be required to remove such adhered sleeves, with the potential for damaging the inner walls of the conduit.

What is needed, therefore, is a method for providing a sacrificial sleeve for the inner walls of a conduit or pipe, while securing at least the upstream end of the sleeve to prevent or reduce the risk of fluid getting behind the sleeve and causing deformation and a collapse. Preferably, such a method would not include the use of adhesives and would allow for easier replacement of worn sleeves.

### SUMMARY OF THE INVENTION

The present invention therefore seeks to provide a retention device and method for securing at least an upstream or leading edge of a wear sleeve within a pipe or conduit interior. The present invention extends to conduits and gap subs comprising such a device.

According to a first broad aspect of the present invention, there is provided a conduit comprising:
an internal conduit wall defining an inner passage through the conduit for receiving and transporting materials;
a wear member positioned within the inner passage and contacting the internal conduit wall; and
at least one retention member for securing an upstream end of the wear member against the internal conduit wall.

In some exemplary embodiments of the first aspect, the internal conduit wall is substantially cylindrical and the wear member is substantially cylindrical, the wear member forming a sleeve that covers at least a portion of the internal conduit wall. The wear member may be composed of a plastic material such as thermoplastics, thermoset polymers, elastomeric polymers or rubber, polyethylene terephthalate, polyether ether ketone or polyphenylene sulfide. Alternatively, the wear member may be composed of a metal material.

The conduit may comprise a gap sub assembly, and the wear member may preferably be composed of an electrically insulative material.

The at least one retention member preferably comprises a ring in engagement (which may, for example, be slip-fit or threaded engagement) with the internal conduit wall, the ring comprising a lip extending in a downhole direction, the lip configured to press a portion of the upstream end of the wear member outwardly against the internal conduit wall. The ring may also comprise a shoulder for abutting engagement with the upstream end of the wear member, and the ring may be in sealing engagement with the internal conduit wall by means of at least one 0-ring. The ring may be composed of a metal selected from the group consisting of beryllium copper and stainless steel, and it may be held in position by abutting against a shoulder on the internal conduit wall.

Alternatively, the at least one retention member may comprise a probe retention member in slip-fit engagement with the internal conduit wall, the probe retention member comprising a lip extending in a downhole direction, the lip configured to press a portion of the upstream end of the wear member outwardly against the internal conduit wall, the probe retention member configured to retain a probe within the inner passage. The probe retention member may be composed of a metal selected from the group consisting of beryllium copper and stainless steel.

The conduit may also comprise at least one downhole retention member for securing a downstream end of the wear member against the internal conduit wall. The at least one downhole retention member may be mounted on the internal conduit wall, or it may be of unitary construction with the internal conduit wall.

According to a second broad aspect of the present invention, there is provided a retention member for securing a wear member inside a conduit, the conduit having an internal wall, the wear member sized and configured for slip-fit engagement with the internal wall, the retention member comprising at least one projection extending adjacent the wear member to hold at least a portion of the wear member against the internal wall.

In some exemplary embodiments of the second aspect, the at least one projection comprises a circumferential lip extending generally parallel to the internal wall. The retention member may further comprise a shoulder for abutting engagement with the at least a portion of the wear member. In some embodiments the retention member may comprise at least one 0-ring for sealing engagement of the retention member against the internal wall. The retention member may also comprise an internal extension for retaining a probe within the conduit. The retention member is preferably composed of a material selected from the group consisting of beryllium copper and stainless steel.

According to a third broad aspect of the present invention, there is provided a wear assembly for use with an internal wall of a conduit, the wear assembly comprising:
a sacrificial sleeve sized and configured for slip-fit engagement with the internal wall; and
a retention member;
the retention member comprising at least one protuberance for securing an upstream end of the sleeve against the internal wall.

In some exemplary embodiments of the third aspect, the sleeve is composed of a plastic material, the plastic material deformable when fluid flowing through the conduit flows under the upstream end of the sleeve, the protuberance sized and configured to retain the upstream end of the sleeve against the internal wall to reduce the flow of the fluid under the upstream end of the sleeve. The retention member may further comprise at least one O-ring for sealing engagement with the internal wall, and the retention member is preferably composed of a material selected from the group consisting of beryllium copper and stainless steel.

The conduit may comprise a gap sub assembly, with the sleeve composed of an electrically insulative material. The electrically insulative material is preferably selected from the group consisting of polyethylene terephthalate, polyphenylene sulfide and polyether ether ketone.

The at least one protuberance preferably comprises a circumferential lip for positioning adjacent the sleeve, and the retention member may further comprise a shoulder for abutting engagement with the upstream end of the sleeve.

A wear assembly according to exemplary embodiments further preferably comprises a downstream retention member for securing a downstream end of the sleeve against the internal wall, and the retention member may further comprise an internal extension for retaining a probe within the conduit.

According to a fourth broad aspect of the present invention, there is provided a gap sub for insertion in a drill string, the gap sub comprising:
a male member;
a female member, the male and female members configured for threadable connection; an electrically insulative gap member configured for positioning between the male and female members;
the male and female members and the gap member when connected forming an internal wall;
a sacrificial sleeve for slip-fit engagement with the internal wall; and
a retention member for slip-fit engagement with the internal wall, the retention member sized and configured to secure an upstream end of the sleeve against the internal wall and reduce introduction under the sleeve of fluid flowing through the gap sub.

In some exemplary embodiments of the fourth aspect, the retention member comprises at least one protuberance for bearing against the upstream end of the sleeve to press the upstream end against the internal wall, and the protuberance preferably comprises a circumferential lip. The retention member may comprise an internally-disposed extension for receiving a probe within the gap sub. The sleeve is preferably composed of an electrically insulative material.

According to a fifth broad aspect of the present invention, there is provided a method of reducing wear of an internal wall of a conduit, the method comprising the steps of:
a. providing a wear member sized and configured for slip-fit engagement with the internal wall;
b inserting the wear member into the conduit so as to engage the internal wall; and
c. engaging retention means to press an upstream end of the wear member against the internal wall.

In some exemplary embodiments of the fifth aspect, the wear member is a sacrificial plastic sleeve, while in other embodiments it is composed of a metal material. The wear member is sized to cover at least a portion of the internal wall. In some embodiments it is advantageous to have the wear member composed of an electrically isolative material, for example where the conduit is a gap sub.

The retention means preferably comprise a retention member sized and configured for slip-fit engagement with the internal wall, and the engaging of the retention means comprises inserting the retention member into the conduit and pressing the retention member against the wear member. Such a retention member preferably comprises at least one downwardly extending protuberance for pressing the upstream end of the wear member against the internal wall, and the at least one downwardly extending protuberance most preferably comprises a circumferential lip. The retention member may also comprise a circumferential shoulder for abutting engagement with the upstream end of the wear member, for securing the wear member in place simultaneously with the pressing of the wear member against the internal wall. In addition, the method may include the step of engaging a downstream retention means to press a downstream end of the wear member against the internal wall.

According to a sixth broad aspect of the present invention, there is provided a method of securing a wear member within an inner passage of a conduit, the inner passage defined by an internal wall of the conduit, the method comprising the steps of:
a. providing the wear member, the wear member sized and configured for slip-fit engagement with the internal wall;
b. inserting the wear member into the inner passage so as to engage the internal wall; and
c. engaging retention means to press an upstream end of the wear member against the internal wall.

In some exemplary embodiments of the sixth aspect, the wear member is a sacrificial plastic sleeve, but in some other embodiments it may be composed of a metal material. In embodiments where the conduit is a gap sub, the wear member is preferably composed of an electrically isolative material. The wear member is preferably sized to cover at least a portion of the internal wall.

The retention means may comprise a retention member sized and configured for engagement (which may, for example, be slip-fit or threaded engagement) with the internal wall, and the engaging of the retention means comprises inserting the retention member into the inner passage and pressing the retention member against the wear member. Such a retention member may comprise at least one downwardly extending protuberance for pressing the upstream end of the wear member against the internal wall, and the at least one downwardly extending protuberance preferably comprises a circumferential lip. The retention member may also comprise a circumferential shoulder for abutting engagement with the upstream end of the wear member, for securing the wear member in place simultaneously with the pressing of the wear member against the internal wall. The method may further comprise engaging a downstream retention means to press a downstream end of the wear member against the internal wall.

A detailed description of exemplary embodiments of the present invention is given in the following. It is to be understood, however, that the invention is not to be construed as being limited to these embodiments. The exemplary embodiments are directed to particular applications of the present invention, while it will be clear to those skilled in the art that the present invention has applicability beyond the exemplary embodiments set forth herein.

### BRIEF DESCRIPTION OF THE DRAWINGS

In the accompanying drawings, which illustrate exemplary embodiments of the present invention:

FIG. 1 is a sectional view of a gap sub with retaining means according to an exemplary embodiment of the present invention, with two detailed views of the downstream and upstream ends of the wear sleeve;

FIG. 2 is a perspective, plan and sectional view of a retaining ring in accordance with an exemplary embodiment of the present invention;

FIG. 3 is a cut-away perspective, sectional and detailed view of an assembly in accordance with an exemplary embodiment of the present invention, with a landing spider and retaining ring in position against a sleeve;

FIG. 4 is a perspective, plan and sectional view of a landing spider in accordance with an exemplary embodiment of the present invention, in which the landing spider comprises the sleeve retention means; and

FIG. 5 is a cut-away perspective, sectional and detailed view of the landing spider of FIG. 4 retaining a sleeve in position.

Exemplary embodiments of the present invention will now be described with reference to the accompanying drawings.

### DETAILED DESCRIPTION OF EXEMPLARY EMBODIMENTS

Throughout the following description specific details are set forth in order to provide a more thorough understanding to persons skilled in the art. However, well known elements may not have been shown or described in detail to avoid unnecessarily obscuring the disclosure. The following description of examples of the technology is not intended to be exhaustive or to limit the invention to the precise forms of any exemplary embodiment. Accordingly, the description and drawings are to be regarded in an illustrative, rather than a restrictive, sense. For example, although the present invention is illustrated as being applied to a gap sub for use in electromagnetic telemetry operations, the present invention may be applied to any appropriate or suitable protective wear and/or electrical isolation member used with pipes or conduits.

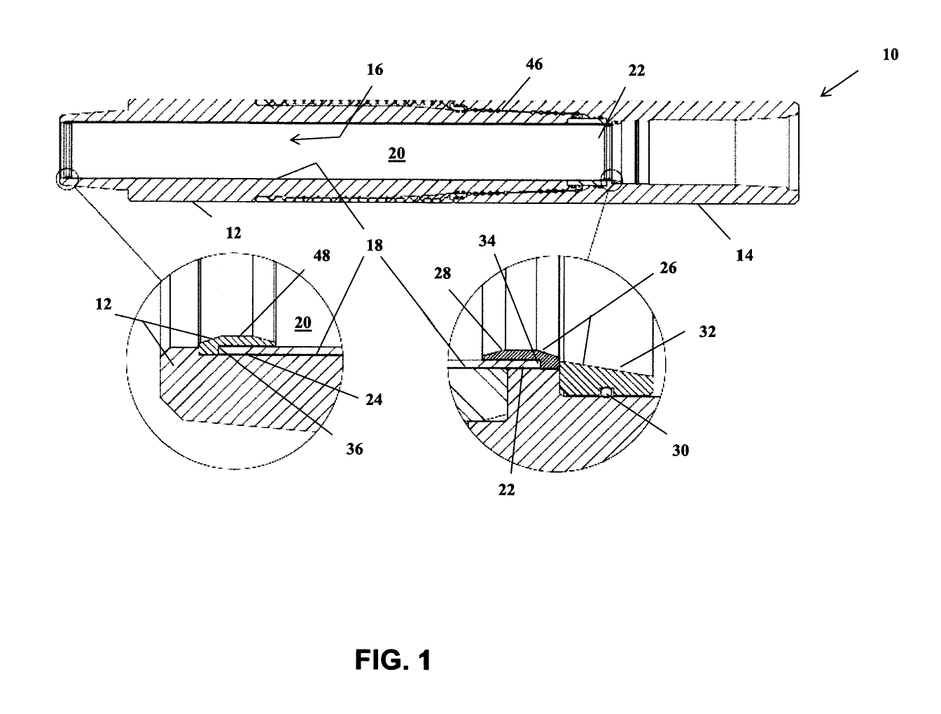

Turning now to FIG. 1, a gap sub 10 is illustrated. The gap sub 10 comprises a male member 12 and a female member 14 separated by a gap member 46, in a manner known to those of skill in the art. The male member 12 and female member 14 are each provided with a bore from one end to the other, to allow for passage of drilling fluid therethrough in operation, forming an inner passage 16. The male member 12 is provided with an internal wall 18 that defines the inner passage 16 in that portion of the gap sub 10.

In the embodiment illustrated in FIG. 1, the internal wall 18 is overlain by a sleeve 20, which in this embodiment is composed of glass filled polyphenylene sulfide, a thermoplastic polymer resin. In the case of a gap sub, such a material may provide suitable wear prevention to the sleeve 20 while providing a desirable electrical isolation function. Those skilled in the art would be able to readily identify other materials that would be appropriate in a given context or application. The sleeve 20 as illustrated is a one-piece cylindrical sleeve that extends substantially the length of the male member 12 interior, between an upstream end 22 and a downstream end 24. It will be obvious to those skilled in the art that the sleeve 20 need not be a one-piece construction in a given application.

A retaining ring 26 is shown in FIG. 1, most particularly in the detailed view of the upstream end 22 of the sleeve 20. The retaining ring 26 is illustrated as a 2-piece unit, but it will be clear to those skilled in the art that the retaining ring could alternatively be formed as a 1-piece unit. The retaining ring 26 is in slip-fit engagement with the internal wall 18 of the male member 12, and an 0-ring 30 is in place to promote a sealing engagement. The retaining ring 26 as illustrated is a ring-shaped member that is in circumferential engagement with the internal wall 18. The retaining ring 26 comprises a lip 28 that is sized and positioned to receive the upstream end 22 of the sleeve 20 and hold it firmly against the internal wall 18. The lip 28 itself extends around the entire circumference of the inner passage 16, thus retaining the upstream end 22 along its full extent. Additional O-rings (not shown) may be positioned beneath the upstream and downstream ends 22, 24 of the sleeve 20 to aid in sealing with the internal wall 18.

The retaining ring 26 further comprises a beveled face 32 to promote flow through the inner passage 16. In addition, the retaining ring 26 comprises a shoulder 34 against which the upstream end 22 of the sleeve 20 abuts, while the downstream end 24 of the sleeve 20 abuts a shoulder 36 on the male member 12, thus holding the sleeve 20 firmly in position when the retaining ring 26 has been inserted into the inner passage 16.

The exemplary embodiment of FIG. 1 includes retention means for the downstream end 24 of the sleeve 20, as well. As can best be seen in the detail view of the downstream end 24, the male member 12 is provided with a downstream lip 48 for securing the downstream end 24 of the sleeve 20, such that both ends 22, 24 of the sleeve 20 are pressed outwardly against the internal wall 18. While this exemplary embodiment shows the lip 48 and the shoulder 36 on a separate component part of the male member 12, the separate component part abutting an internal shoulder of the male member 12, it will be clear to those skilled in the art that the lip 48 and the shoulder 36 could be of unitary construction with the male member 12 in an alternative embodiment.

In the exemplary embodiment, the sleeve 20 is shown as secured by means of a slip-fit engagement with the upstream and downstream lips 28, 48 and abutting against the upstream and downstream shoulders 34, 36. However, it is within the scope of the present invention to have other mechanisms for pressing the upstream and downstream ends 22, 24 against the internal wall 18, such as for example a biasing mechanism. Those skilled in the art would be able to readily determine functionally equivalent mechanisms and techniques, all of which are intended to fall within the scope of the present invention as defined in the claims.

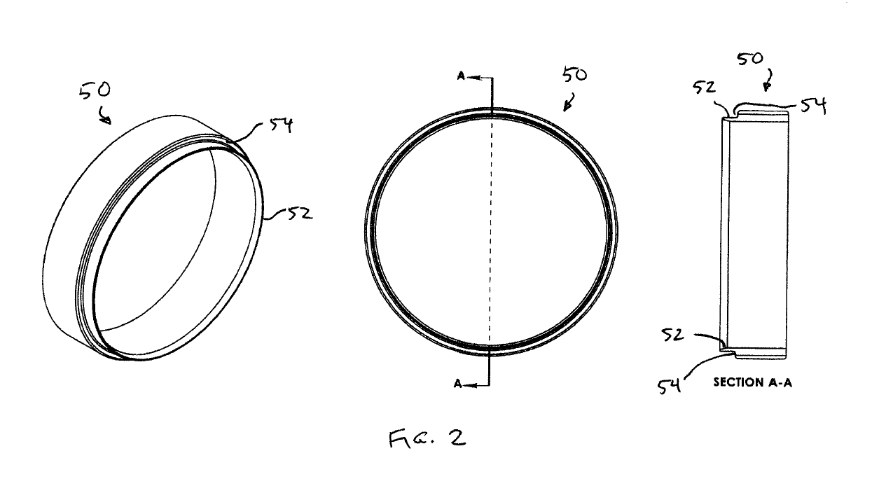

Turning now to FIG. 2, a slightly modified retaining ring 50 is illustrated. The retaining ring 50 comprises a circumferential lip 52 and a shoulder 54, which function in a similar manner to the above description, but in this case there is no O-ring or other sealing feature on the side of the retaining ring 50, unlike the embodiment of FIG. 1.

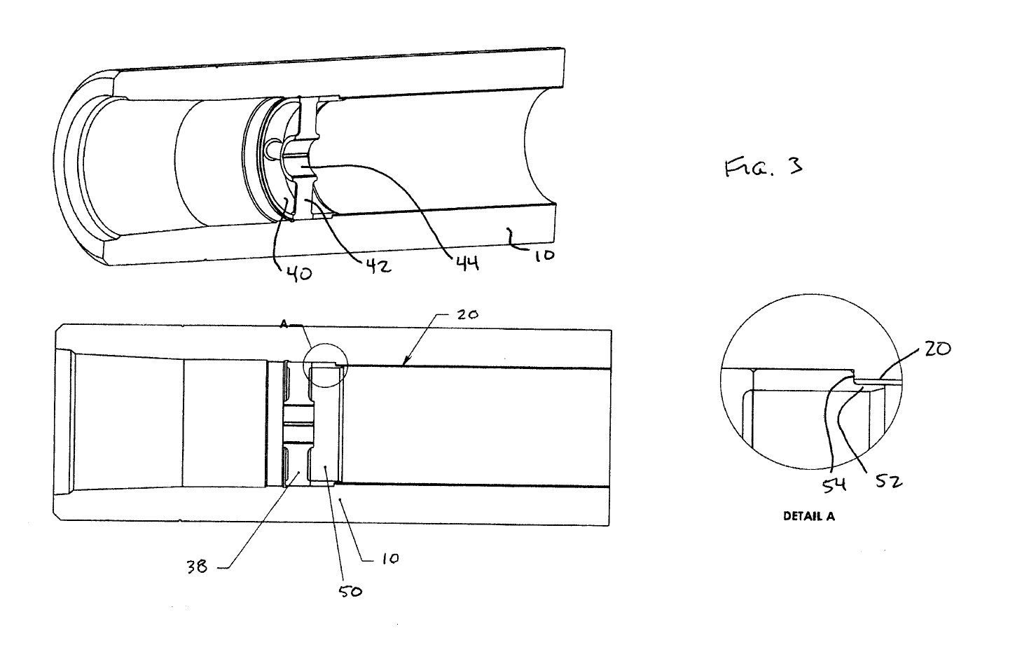

FIG. 3 illustrates a further exemplary embodiment of the present invention. In this embodiment, a landing spider 38 is inserted on top of the retaining ring 50 and a castle nut (not shown) further secures the landing spider 38 and the retaining ring 50 in place. The landing spider 38 is used to hold an electronics package, such as for example a probe for use in electromagnetic telemetry. The landing spider 38 comprises a peripheral ring 40 for slip-fit engagement with the internal wall 18 of the gap sub 10, a plurality of arms 42 extending inwardly from the peripheral ring 40, and a central mating hub 44 connected to the arms 42 and configured for retention of a given electronics package.

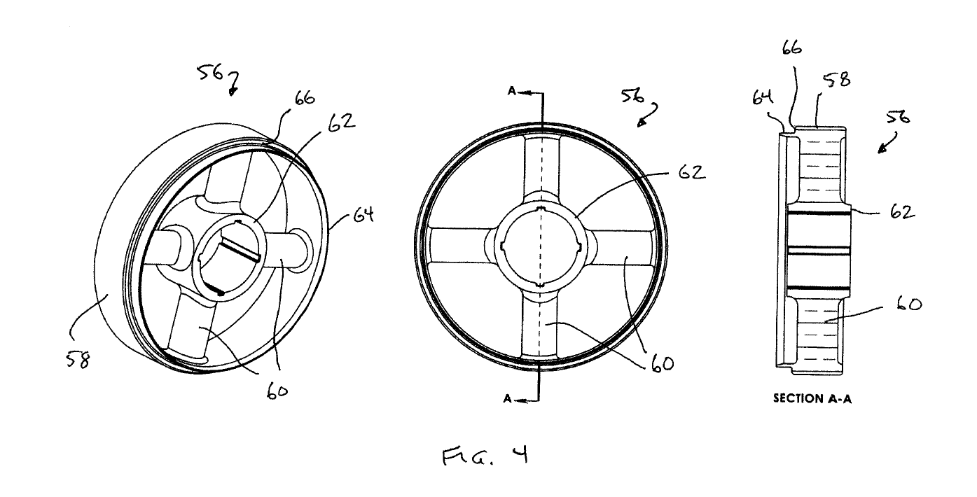

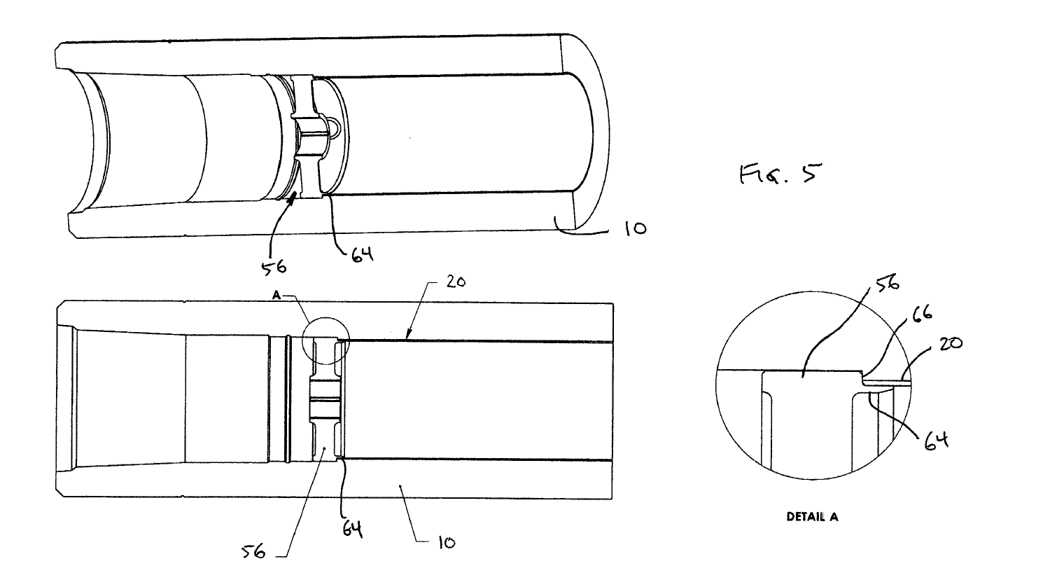

FIGS. 4 and 5 illustrate a further exemplary embodiment. In this embodiment, the retaining ring has been replaced by a modified landing spider 56 which combines the sleeve-securing and probe-holding functionalities in one device. The landing spider 56 comprises a peripheral ring 58, arms 60 and a central mating hub 62, with functionality as described above, but it also comprises a circumferential lip 64 and shoulder 66. The circumferential lip 64 and shoulder 66 function is a similar way to the above description regarding the embodiment of FIG. 1, working together to secure the upstream end 22 of the sleeve 20 against the internal wall 18 of the gap sub 10.

As will be clear from the above, those skilled in the art would be readily able to determine obvious physical variants capable of providing the retaining ring functionality, and all such variants and functional equivalents are intended to fall within the scope of the present invention.

The present invention also extends to methods or reducing conduit wall wear and securing protective wear members.

In one exemplary embodiment of a method according to the present invention, the method is for reducing wear of an internal wall of a conduit. Reference will be made to the elements shown in FIG. 1 for ease of description. A sleeve 20 is manufactured to a suitable size and configuration for slip-fit engagement with the internal wall 18. The sleeve 20 is inserted into the inner passage 16 of the female member 14, abutting against the downstream shoulder 36 of the separate component part of the male member 12 and pressed against the internal wall 18 by means of the downstream lip 48. The retaining ring 26 is then inserted through the inner passage 16 of the female member 14 until it meets the sleeve 20. The retaining ring 26 is pressed downwardly against the upstream end 22 of the sleeve 20 until the upstream end 22 is seated against the upstream shoulder 34, and the upstream end 22 will thus be pressed against the internal wall 18 by the lip 28, as described above. With the sleeve 20 thus positioned and retained against the internal wall 18, this exemplary embodiment may help to reduce wear of the internal wall 18.

As indicated above, this exemplary method may further include inserting a landing spider or similar internal probe mechanism. Alternatively, as set out above, the landing spider itself could comprise the sleeve retention features of the retaining ring 26.

In another exemplary embodiment of a method according to the present invention, the method is for securing a wear member within an inner passage of a conduit, the inner passage defined by an internal wall of the conduit. Reference will again be made to the elements shown in FIG. 1 for ease of description. A sleeve 20 is manufactured to a suitable size and configuration for slip-fit engagement with the internal wall 18. The sleeve 20 is inserted into the inner passage 16 of the female member 14, abutting against the downstream shoulder 36 and pressed against the internal wall 18 by means of the downstream lip 48. The retaining ring 26 is then inserted through the inner passage 16 of the female member 14 until it meets the sleeve 20. The retaining ring 26 is pressed downwardly against the upstream end 22 of the sleeve 20 until the upstream end 22 is seated against the upstream shoulder 34, and the upstream end 22 will thus be pressed against the internal wall 18 by the lip 28, as described above. As indicated above, this exemplary method may further include inserting a landing spider or similar internal probe mechanism. Alternatively, as set out above, the landing spider itself could comprise the sleeve retention features of the retaining ring 26. Thus, the sleeve 20 is secured in place in a novel manner and without the use of adhesives.

As will be clear to those of skill in the art, the present invention allows for a wear member application that can easily be replaced. When it is determined that the time has come for the sleeve 20 to be replaced, the section of conduit can be taken out of operation. The retaining ring 26 can be pulled away from the upstream end 22 of the sleeve 20, thus freeing the upstream end 22. The sleeve 20 can then be pulled away from the downstream shoulder 36 and disengaged from the downstream lip 48, and then withdrawn from the inner passage 16. A replacement sleeve can then be inserted and retention ring 26 re-installed as set out above. The gap sub 10 can then be returned to operation.

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”.
“connected”, “coupled”, or any variant thereof, means any connection or coupling, either direct or indirect, between two or more elements; the coupling or connection between the elements can be physical, logical, or a combination thereof.
“herein”, “above”, “below”, and words of similar import, when used to describe this specification shall refer to this specification as a whole and not to any particular portions of this specification.
“or”, in reference to a list of two or more items, covers all of the following interpretations of the word: any of the items in the list, all of the items in the list, and any combination of the items in the list.
the singular forms “a”, “an” and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present) depend on the specific orientation of the apparatus described and illustrated. The subject matter described herein may assume various alternative orientations. Accordingly, these directional terms are not strictly defined and should not be interpreted narrowly.

Where a component (e.g. a circuit, module, assembly, device, drill string component, drill rig system etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of methods and apparatus have been described herein for purposes of illustration. These are only examples. The technology provided herein can be applied to contexts other than the exemplary contexts described above. Many alterations, modifications, additions, omissions and permutations are possible within the practice of this invention. This invention includes variations on described embodiments that would be apparent to the skilled person, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

The foregoing is considered as illustrative only of the principles of the invention. The scope of the claims should not be limited by the exemplary embodiments set forth in the foregoing, but should be given the broadest interpretation consistent with the specification as a whole.

1-18. (canceled)

19. A retention member for securing a wear member inside a conduit, the conduit having an internal wall, the wear member sized and configured for slip-fit engagement with the internal wall, the retention member comprising at least one projection extending adjacent the wear member to hold at least a portion of the wear member against the internal wall;
the wear member removable and internally collapsible and slidably positioned within the conduit and contacting the internal wall; and
the retention member configured for removable receipt within the conduit and the at least one projection configured for securing an upstream end of the wear member against the internal wall and preventing internal collapse of the wear member.

20. The retention member of claim 19 wherein the at least one projection comprises a circumferential lip extending generally parallel to the internal wall.

21. The retention member of claim 19 further comprising a shoulder for abutting engagement with the at least a portion of the wear member.

22. The retention member of claim 19 further comprising at least one 0-ring for sealing engagement of the retention member against the internal wall.

23. The retention member of claim 19 further comprising an internal extension for retaining a probe within the conduit.

24. The retention member of claim 19 composed of a material selected from the group consisting of beryllium copper and stainless steel.

25-34. (canceled)

35. A gap sub for insertion in a drill string, the gap sub comprising:
a male member;
a female member;
an electrically insulative gap member configured for positioning between the male and female members;
the male and female members and the gap member when connected forming an internal wall;
a sleeve for engagement with the internal wall, the sleeve removable and internally collapsible and contacting the internal wall; and
a retention member for engagement with the internal wall, the retention member sized and configured to secure an upstream end of the sleeve against the internal wall and reduce introduction under the sleeve of fluid flowing through the gap sub, the retention member configured for securing an upstream end of the sleeve against the internal wall and preventing internal collapse of the sleeve.

36. The gap sub of claim 35 wherein the retention member comprises at least one protuberance for bearing against the upstream end of the sleeve to press the upstream end against the internal wall.

37. The gap sub of claim 36 wherein the protuberance comprises a circumferential lip.

38. The gap sub of claim 35 wherein the retention member comprises an internally-disposed extension for receiving a probe within the gap sub.

39. The gap sub of claim 35 wherein the sleeve is composed of an electrically insulative material.

40. A method of reducing wear of an internal wall of a conduit, the method comprising the steps of:
a. providing a wear member sized and configured for slip-fit engagement with the internal wall, the wear member removable and internally collapsible and slidably positioned within the conduit and contacting the internal wall;
b inserting the wear member into the conduit so as to engage the internal wall; and
c. engaging retention means to press an upstream end of the wear member against the internal wall, the retention means removably received within the conduit and configured for securing an upstream end of the wear member against the internal wall and preventing internal collapse of the wear member.

41. The method of claim 40 wherein the wear member is a sacrificial plastic sleeve.

42. The method of claim 40 wherein the wear member is sized to cover at least a portion of the internal wall.

43. (canceled)

44. The method of claim 40 wherein the wear member is composed of an electrically isolative material.

45. The method of claim 40 wherein the retention means comprise a retention member sized and configured for engagement with the internal wall, and the engaging of the retention means comprises inserting the retention member into the conduit and pressing the retention member against the wear member.

46. The method of claim 45 wherein the retention member comprises at least one downwardly extending protuberance for pressing the upstream end of the wear member against the internal wall.

47. The method of claim 46 wherein the at least one downwardly extending protuberance comprises a circumferential lip.

48. The method of claim 45 wherein the retention member comprises a circumferential shoulder for abutting engagement with the upstream end of the wear member, for securing the wear member in place simultaneously with the pressing of the wear member against the internal wall.

49. The method of claim 40 further comprising engaging a downstream retention means to press a downstream end of the wear member against the internal wall.

50-59. (canceled)
